(19) United States
(12) Patent Application Publication
(10) Pub. No.: US 2026/0138115 A1
(43) Pub. Date: May 21, 2026

(54) Method for Carrying Out a Chemical Reaction and Reactor Arrangement

(71) Applicants: LINDE GMBH, Pullach (DE); BASF SE, Ludwigshafen (DE); SABIC Global Technologies B.V., Bergen op Zoom (NL)

(72) Inventors: Mathieu Zellhuber, Martinsried (DE); Martin Hofstätter, München (DE); Kiara Aenne Kochendörfer, Mannheim (DE); Andrey Shustov, Ludwigshafen am Rhein (DE); Eric Jenne, Hassloch (DE); Andrea Haunert, Ludwigshafen (DE); Scott A. Stevenson, Houston, TX (US); Andrew M. Ward, Yorkshire (GB)

(21) Appl. No.: 19/120,686

(22) PCT Filed: Oct. 11, 2023
(86) PCT No.: PCT/EP2023/078264

§ 371 Date: Apr. 11, 2025

(30) Foreign Application Priority Data
Oct. 12, 2022 (EP) 22020489.5

(51) Int. Cl. B01J 19/24; B01J 3/00; B01J 19/00

(52) U.S. Cl. CPC B01J 19/2415; B01J 3/00; B01J 19/0013; B01J 2219/00132; B01J 2219/00162; B01J 2219/00164; B01J 2219/0871

(57) ABSTRACT

In a method for carrying out a chemical reaction, a reactant is supplied to the reaction tube in a reactor vessel in a first mass flow during a first operation mode and is supplied in a second lower mass flow during a second operation mode. An electric heating element in the reactor vessel supplies radiant heat during the first operation mode in a first heat flow and in a second heat flow which is lower on a time average. In the reactor vessel in which the one or more heating elements are provided, a gas atmosphere is provided in which a content of oxygen is adjusted in a predetermined volume fraction. During the first operating mode the volume fraction of oxygen is adjusted between no less than 500 ppm and no more than 10%. During the second mode, the volume fraction of oxygen is adjusted to a higher value.

### CROSS-REFERENCE TO RELATED APPLICATIONS

This application is the national stage of, and claims priority to, International Application No. PCT/EP2023/078264, filed 11 Oct. 2023, which claims priority to European Application No. EP 22020489.5, filed 12 Oct. 2022.

### FIELD OF THE INVENTION

The invention relates to a process for carrying out a chemical reaction and to a corresponding reactor arrangement.

### BACKGROUND

In a number of processes in the chemical industry, reactors are used in which one or more reactants are passed through heated reaction tubes where they are catalytically or non-catalytically reacted. The heating serves in particular to overcome the activation energy required for the chemical reaction taking place and, in the case of endothermic reactions, to provide the necessary energy for the chemical reaction. The reaction can proceed endothermically overall or, after overcoming the activation energy, exothermically. The invention relates in particular to strongly endothermic reactions, as further discussed below.

Examples of such processes are steam cracking, various reforming processes, in particular steam reforming, dry reforming (carbon dioxide reforming), mixed reforming processes, processes for the dehydrogenation of alkanes and the like. In steam cracking, the reaction tubes are guided through the reactor in the form of coils, which have at least one reverse bend in the reactor, whereas in steam reforming, tubes are typically used which run through the reactor without a reverse bend. The present invention may also be used in connection with so-called “millisecond” or “single-pass” reactors which are characterized by very low dwell times.

Further applications of the invention are reactors for performing a reverse water gas shift (RWGS) reaction of carbon dioxide and hydrogen to form carbon monoxide and water, dehydrogenation of oxygenates such as a reaction of methanol to formaldehyde and hydrogen, cleavage of ammonia to yield gaseous nitrogen and hydrogen, dehydrogenation of so-called liquid organic hydrogen carriers (LOHC) as known to the skilled person, and reforming of methanol and glycerol (as far as not already included by the term “reforming” used above).

The invention is suitable for all such processes and embodiments of reaction tubes. Purely by way of illustration, reference is made to the articles “Ethylene”, “Gas Production” and “Propene” in Ullmann's Encyclopedia of Industrial Chemistry, for example the publications dated Apr. 15, 2009, DOI: 10.1002/14356007.a10_045.pub2, Dec. 15, 2006, DOI: 10.1002/14356007.a12_169.pub2, and Jun. 15, 2000, DOI: 10.1002/14356007.a22_211.

The reaction tubes of corresponding reactors are conventionally heated by using burners. The reaction tubes are, for this purpose, guided through a combustion chamber in which the burners are also arranged.

Currently, however, demand is increasing for synthesis products such as olefins, but also for synthesis gas and hydrogen, which are produced with no or reduced local carbon dioxide emissions. This demand cannot be met by processes using fired reactors due to the use of typically fossil fuels. Other processes are practically excluded due to high costs, for example.

It has therefore been proposed to support or replace the burners in corresponding reactors by electrical heating means. In addition to direct electrical heating, in which current is applied to the reaction tubes themselves, for example in a known star (point) circuit, and other types of heating, which are not explained in detail here, concepts also exist in particular for so-called indirect electrical heating. This is also used in the context of the invention. Irrespective of the specific type of heating and the heating concept implemented in the process, appropriately heated reactors are also referred to as “furnaces”.

Such indirect electrical heating can be carried out, as explained e.g. in WO 2020/002326 A1, using electrically operated radiative heating elements (“radiant heaters”) suitable for heating to the high temperatures required for the reactions mentioned, such heating elements being arranged within the furnace in such a way that they are not in direct contact with the reaction tubes. The heat transfer takes place predominantly or exclusively in the form of radiant heat. Therefore, the terms “indirect heating”, “heating by means of radiant heat” and the like are used synonymously below. Properties of corresponding heating elements are explained below.

Some further examples of prior art documents are discussed below, without any concession, however, that these documents in any way anticipate, suggest, or otherwise relate to, aspects of the invention and its embodiments described below.

Methods and systems for using temperature measurements taken from a compact insulated skin thermowell to optimize a pyrolysis reaction are provided according to WO 2019/133215 A1. In systems and methods disclosed in this document, the upstream temperature and the upstream pressure of a pyrolysis reactor is measured through an adiabatic restriction in the inlet manifold of a parallel tube assembly to provide an absolute upstream temperature and an upstream pressure. The downstream temperature of the pyrolysis reactor is also measured following an adiabatic restriction to provide an absolute downstream temperature. The downstream pressure is then determined by multiplying the absolute upstream pressure with the quotient of the downstream temperature divided by the upstream temperature as taken to the power of k/k−1, where k is the ratio of fluid specific heat at constant pressure (Cp) to fluid specific heat at constant volume (Cv).

In US 2019/002389 A1, a process for continuously preparing the tert-butyl ester of an ethylenically unsaturated carboxylic acid, by a) reacting an ethylenically unsaturated carboxylic acid with isobutene in the presence of an acidic catalyst to give an esterification mixture; b) removing the acidic catalyst; c) removing low-boiling components; and d) supplying a tert-butyl ester-comprising liquid to a distillation apparatus and subjecting it to purifying distillation in the distillation apparatus is disclosed, where d1) in the distillation apparatus the tert-butyl ester-comprising liquid is separated into a tert-butyl ester-comprising gaseous top product and a carboxylic acid-comprising liquid bottom product; d2) the tert-butyl ester-comprising gaseous top product is at least partly condensed and the condensate is recycled partly as reflux to the distillation apparatus; d3) the carboxylic acid-comprising liquid bottom product is recycled at least partly to step a); d4) carboxylic acid-comprising liquid bottom product is drawn off and passed to a heater; a superheated, liquid recycle stream is taken from the heater; and the superheated recycle stream is let down into the distillation apparatus; and d5) at least in the top region of the distillation apparatus, the distillation apparatus walls in contact with the vapor, at least in sub-regions, are heated and/or thermally insulated. In the course of the process, the separation of the tert-butyl ester from unreacted carboxylic acid is carried on with a particularly low level of accompanying polymerization both of the tert-butyl ester and of the carboxylic acid.

According to EP 1 273 552 A2, a hydrogen producing device for supplying at least one type of material to a reaction part together with air, oxygen, or an oxidizing agent to produce hydrogen by a specific chemical reaction is provided, wherein for the at least one type of material, a supply amount of each material is set by selecting one from two or more set values which are previously determined corresponding to required hydrogen production volumes; and for the air, oxygen, or oxidizing agent, a supply amount of the air, oxygen, or oxidizing agent is varied and controlled so that a temperature of a reaction part is within a preset temperature range.

EP 4 056 892 A1 discloses a method of steam cracking using a steam cracking system including a first steam cracking furnace unit or a plurality of first steam cracking furnace units and a second steam cracking furnace unit or a plurality of second steam cracking furnace units, wherein the first steam cracking furnace unit or each of the plurality of first steam cracking furnace units comprises one or more fired steam cracking furnaces, the second steam cracking furnace unit or each of the plurality of second steam cracking furnace units comprises one or more electric steam cracking furnaces, and the first steam cracking furnace unit or each of the plurality of first steam cracking furnace units comprises means for preheating at least a part of combustion air provided to its fired steam cracking furnace or furnaces to a temperature level of at least 100° C.

EP 3 862 076 A1 relates to a reactor for carrying out a chemical reaction, the reactor having a reactor vessel and one or more reaction tubes, wherein a number of tube lengths of the one or more reaction tubes run respectively between a first region and a second region within the reactor vessel, and wherein the tube lengths can each be electrically connected, in the first region, to the phase terminals of a polyphase alternating current source for the purpose of heating the tube lengths. According to this document, the tube lengths are connected to one another in an electrically conductive manner in the second region as a whole by means of a single rigid connecting element or in groups by means of multiple rigid connecting elements, which connecting element(s) is/are connected in one piece to the single or multiple reaction tube(s) and is/are arranged within the reactor vessel.

WO 2020/002326 A1 relates to a reactor configuration comprising at least one electrically heated furnace which defines a space, with at least one reactor tube placed within the furnace space and said reactor tube having an exit and entrance outside of the reactor furnace, and wherein said furnace is further provided with—at least one electrical radiative heating element suitable for heating to high temperatures in the range of 400 to 1400° C., said heating element being located inside said furnace in such a way that the heating element is in no direct contact with the at least one reactor tube; and; and—a number of inspection ports in the furnace wall such to be able to visually inspect the condition of the at least one reactor tube on each opposite side of said reactor tube during operation, the total number of inspection ports being sufficient to inspect all reactor tubes present in the furnace at their full length and circumference; and wherein the heating duty of the furnace is at least 3 MW. The process being electrically heated demands a heat-flux and temperature profile. In many applications the heat-flux is larger when the process enters the furnace whilst having a lower temperature. Towards the exit the heat-flux is lower whilst having higher temperature. The claimed invention can accommodate this requirement. The reactor is useful in many industrial scale high temperature gas conversion and heating technologies.

US 2020/299131 A1 discloses that liquid fuel catalytic partial oxidation (CPOX) reformer and fuel cell systems can include a plurality or an array of spaced-apart CPOX reactor units, each reactor unit including an elongated tube having a gas-permeable wall with internal and external surfaces. The wall encloses an unobstructed gaseous flow passageway. At least a portion of the wall has CPOX catalyst disposed therein and/or comprising its structure. The catalyst-containing wall structure and open gaseous flow passageway enclosed thereby define a gaseous phase CPOX reaction zone, the catalyst-containing wall section being gas-permeable to allow gaseous CPOX reaction mixture to diffuse therein and hydrogen rich product reformate to diffuse therefrom. The liquid fuel CPOX reformer also can include a vaporizer, one or more igniters, and a source of liquid reformable fuel. The hydrogen-rich reformate can be converted to electricity within a fuel cell unit integrated with the CPOX reactor unit.

The claimed invention has an object of providing measures which permit advantageous operation of a reactor of the type explained which is indirectly electrically heated using appropriate heating elements.

### SUMMARY

Against this background, the invention described herein proposes a process for carrying out a chemical reaction and a corresponding reactor arrangement.

The invention relates to a process for carrying out a chemical reaction, in which a reactor arrangement is used in which reaction tubes arranged in a reactor vessel are provided. One or more reactants are supplied to (and passed through) the reaction tubes in a first mass flow during one or more first modes of operation, and are not supplied to (and passed through) the reaction tubes during one or more second modes of operation, or these reactants are supplied (and passed through) the reaction tubes during these one or more second modes of operation in a second mass flow that is lower, at least on a time-average basis, than the first mass flow. With “on a time-average basis” it is meant that the flows may fluctuate during a certain time period but the average flow over this time period is characterized by being lower in the second mode of operation. The time basis may be the one or each of the plurality of second modes of operation, in particular compared to the one or each of the plurality of first modes of operation or a corresponding time-average basis. Other reactants may also be used in the one or more second modes of operation as compared to the first mode of operation, such as air in a decoking mode. Different reactants may also be used in a plurality of second modes of operation in respect to each other.

In this regard, the one or more first modes of operation may correspond to, or may be performed during, one or more reaction time periods explained in more detail below. The one or more second modes of operation may correspond to, or may be performed during, one or more heat-up, cool-down, load change, decoking, or standby time periods, also discussed below.

The invention is particularly advantageous in being able to handle (severe) load changes. Such load changes can occur between the first operating mode(s) and the second operating mode(s) or between different second operating modes, as previously expressed with the term “load change periods”. In particular, load changes associated with different power outputs of the heating elements place a particularly high load on the latter. The invention remedies this situation as further explained below.

According to the invention, radiant heat provided by means of one or more electrical heating elements disposed in the reactor vessel is supplied to the reaction tubes in a first heat flux during the one or more first modes of operation and is not supplied to the reaction tubes during the one or more second modes of operation, or is supplied to the reaction tubes during the one or more second modes of operation in a second heat flux which is, at least in a time-average, lower than in the first mode of operation. As to the meaning of “in a time average”, reference is made to the explanations above. Like above, a corresponding time may be one or more periods of time in which the one or more second modes of operation are performed, in particular as compared to one or more periods of time in which the one or more first modes of operation are performed, or again a corresponding time average. As explained below, the reaction tubes can thereby be maintained at temperatures in different temperature ranges. In particular, the first heat flux can be provided by operating the heating element or elements at a constant or substantially constant power input or current, and the second heat flux can be provided by operating the heating element or elements at a lower power input or current (at least on a time-average basis), which may also vary accordingly over time. It is not essential to the invention that the heating element or elements provide any heat flux at all in the one or more second modes of operation. In the one or more second modes of operation, instead, a so-called “hot steam standby” can also be carried out, for example, in which steam is passed through the reaction tubes to keep them at a certain temperature, i.e. to maintain them at a predefined temperature or in a predefined temperature range, but the heating elements are set to low power consumption or current flow or, optionally, to no operation at all.

The reaction tube temperatures achieved by using the first heat flow at the reaction tubes can be selected to be identical or comparable to fired furnaces or other electrically heated furnaces. They cover comparatively wide temperature ranges, since a not inconsiderable temperature gradient always occurs in corresponding reaction tubes (“cold” inlet and “hot” outlet, especially with increasing coking). When radiant heating elements are used, the provision of the above reaction tube temperature levels requires even higher temperatures at the heating elements due to the high heat flows required. In simplified words, the average heating elements temperatures generally “float” above the average reaction tube temperature levels, with the “floating height” between these temperatures scaling with the heat flux density required by the process at the moment of operation. The higher the required average heat flux density, the larger the average temperature difference between heating elements and reaction tubes. Nevertheless, the local temperature at a specific heating element surface location will vary and result from the complex thermal equilibration process at the given location involving all relevant heat transfer mechanisms (radiation, convection, conduction) and Joule heating caused by electrical currents.

The invention can be used, as mentioned, in particular in connection with the production of olefins and/or other synthesis products by steam cracking or in connection with the production of synthesis gas or hydrogen by steam reforming, as mentioned at the outset. However, the invention is suitable in principle for all types of reactions in which a feed mixture is passed in a gaseous state through reaction tubes heated from the outside to appropriate temperature levels and is thereby reacted.

The reaction tubes can be guided through the reactor vessel in any way conceivable, in particular with or without one or more reverse points or reverse bends. In particular, they can be arranged in a single row in a vertically arranged plane and heated by means of radiation heating elements arranged on both sides of the plane. A multi-row arrangement in an intermediate area between two planes and corresponding heating from outside the intermediate area is also possible. In particular, the reaction tubes have a length of 5 to 100 m and/or a diameter of 20 to 200 mm. Furthermore, the individual reaction tubes can be designed in sections in two or more parallel strands with reduced tube diameters as compared to a single tube. Preferably, the multi-strand section is arranged close to the entry into the furnace in order to provide the highest possible length-specific reaction tube wall area in this region. Further downstream in this arrangement, the initially parallel strands are combined into a common strand with a preferably larger tube diameter. In this example, the reaction tube consists of the two or more parallel strands, the junction, particularly including a connection fitting, and the united strand. Conversely, it is also possible in principle to provide a multi-strand design of the reaction tube at the end or in the middle section, with intermediate dividing and, if necessary, additional joining pieces. Generally, tubes may be split and combined in embodiments of the invention in any conceivable manner. The reaction tubes can also be filled with a suitable catalyst material and/or an inert material or may be provided in an empty form, depending on the type of reaction.

The invention provides for heating of the reaction tubes using electrically provided radiant heat. However, this does not preclude the use of other types of heating in addition, for example, direct heating in which the reaction tubes themselves are used as electrical resistors to generate heat, inductive heating or, in further reactor vessels of the reactor arrangement, heating using burners. In either case, in addition to radiant heat, some of the heat provided by means of an appropriate heating element may also be convectively transferred to the reaction tubes.

Therefore, if reference is made here to the use of indirect electrical heating, i.e. the use of radiant heat provided by means of electrical heating elements, this does not exclude the presence of additional electrical or non-electrical heating. In particular, it may also be envisaged to vary the contributions of the types of electrical and, in particular, non-electrical heating over time, for example as a function of the supply and price of electricity or the supply and price of non-electrical energy sources.

A “reactor vessel” is understood here to mean an enclosure which is partially or completely thermally insulated from the outside and which can in particular be lined with a material which is thermally resistant at the temperatures mentioned. The reactor vessel is in particular surrounded predominantly, i.e. to at least 90%, 95%, 99%, 99.5% or 99.8%, by (solid) wall having thermally insulating properties. These walls may comprise a tight, continuous or impervious backlayer, such as a metallic sheet, and one or more insulation layers. The figures given for the proportion in which the reactor vessel is “surrounded by a thermically insulating wall” may, in this connection, particularly be understood as a proportion of overall housing of the reactor vessel which is made up of solid structures having thermally insulating properties, i.e. which are cladded with, or made from or include, a thermally insulating material. Openings or ports of the reactor housing, which are typically not provided as being fully thermally insulating, may not be included in the figures given for the “predominantly surrounded” reactor vessel. Any part of the reactor wall which is, as understood herein, provided as being “thermally insulating” may have a thermal transmittance below 2 W/m²K, particularly below 1.5 W/m²K, below 1 W/m²K, below 0.5 W/m²K or below 0.2 W/m²K. The term “thermal transmittance” is intended to express that the value indicated by the associated figure refers (only) to the conductive heat transfer coefficient in the solid structure (particularly excluding radiative and convective heat transfer components on the inside and outside of the wall). For example, if the reactor vessel is surrounded to at least x % by the thermally insulating wall, as indicated above, these x % of wall area or less may be configured to have a thermal transmittance as just indicated. As mentioned, openings or ports of a reactor housing may not be thermally insulated accordingly and therefore their thermal transmittance may be higher, or, e.g. in case of permanent openings, they may not represent any thermal barrier at all. To provide a reactor wall in a thermally insulating configuration, the wall may, as mentioned, be made up of, include, or be cladded with, a thermally insulating material such as, but not limited to, ceramic fibers, heat-reflecting metal foils, minerals, and expanded polymers or any combination thereof. Different thermally insulating materials may be provided, particularly in correspondence with local temperatures present and with different thermal resistances.

As mentioned, the invention is not limited to the use of exactly one reactor vessel, but can in particular also be used in arrangements with differently heated reactor vessels. Further details on corresponding reactor vessels and their equipment with gas feed devices and, if applicable, gas extraction devices and their connection to stacks and the like are explained further below. Herein, the terms (exiting) “stack” and “chimney” are used as synonyms and both relate to a structure with a (main) function of providing a fluid connection to a safe outlet location, e.g. to the atmosphere, preferably at sufficient height from the ground.

In the context of the invention, a reactor vessel does not need to be designed to be gas-tight, or at least not completely gas-tight. According to embodiments of the invention, the reactor vessel is particularly provided as being sufficiently gas tight to be able to practically control the oxygen level inside the vessel. As mentioned herein, a defined oxygen concentration is particularly advantageous at the heating elements and therefore the gas tightness of the reaction vessel is particularly relevant in proximity thereof. Therefore, the walls of the reactor vessel may be provided in a lower gas tightness in proximity to the heating elements. This is, however, not provided in all embodiments of the invention. For the avoidance of doubt, the gas tightness may not pertain to any purposely introduced gas, even if this gas flows under the influence of a pressure differential between the outside and the inside, i.e. across a wall, of the reactor vessel.

A “reaction period” is understood here to mean a period of time or a partial period of a corresponding period of time during which the reaction carried out takes place and during which the reactants required for the reaction are passed through the reaction tubes. This particularly corresponds to the first mode(s) of operation. Typically, during a reaction period, flammable components, in particular hydrocarbons, are contained in the process feed gas and are therefore passed through the reaction tubes. In periods other than the reaction period, such as in regeneration periods or inertization periods (i.e, particularly in the second mode(s) of operation), such flammable components are typically not passed through the reaction tubes.

The reaction tubes are, in embodiments of the invention, heated up during periods lying before the actual reaction periods to the reaction tube temperature level at which they are maintained during the reaction period and/or in each case cooled during cooling periods lying after these reaction periods, starting from this reaction tube temperature level. The reaction period(s) are, in particular, periods during which “one or more first operating modes” are carried out in the sense understood here, whereas heating or cooling periods are, in particular, periods during which “one or more second operating modes” are carried out in the sense understood here, as already mentioned before. Heating up takes place in particular after a (temporary) decommissioning of the reactor arrangement, for example for cleaning, decoking, repair and/or maintenance. Cooling down accordingly takes place before a (temporary) decommissioning and may comprise an active or passive cooling down (i.e. “letting cool down” the reactor).

As is generally known, processes of the type explained can in particular also include a decoking operation in which deposits formed in the reaction tubes after a corresponding reaction period are removed, for example by “burning off” by means of an oxygen-containing gas or gas mixture. This is particularly the case in pure gas phase reactions without the use of a catalyst. Before a corresponding decoking operation, the reaction tubes are typically freed from the reactants and, in particular, a preliminary cooling or subsequent heating is carried out. Corresponding periods of a decoking operation, but also, for example, of a standby operation with pure steam addition into the reaction tubes to avoid (excessive) cooling (so-called “hot-steam standby operation”) and periods of cooling or heating do not count, in the understanding used herein, as part of the reaction period. That is, “one or more first modes of operation” are not carried out in corresponding periods, just as little as, for example, maintenance periods or periods in which a catalyst bed is replaced or regenerated. These periods are those in which “one or more second modes of operations” are carried out.

To summarize what was just explained, the reaction tubes may, during the one or more second modes of operation, be operated in at least one of a steam standby mode in which the reaction tubes are maintained at a predefined temperature or in a predefined temperature range by passing steam therethrough, operated in a decoking mode in which the reaction tubes are decoked by passing steam and air therethrough, and operated in a transient cracking mode in which a reaction feed load passed through the reaction tubes and/or the process gas temperature at the outlet of the reaction tube is changed over time. The heating elements may be operated or not operated, depending on the specific mode of operation. Particularly, in the steam standby mode the heating elements may be out of operation, but can also be operated in a “hot” steam standby. In a decoking mode, the heating elements may particularly be in operation while in the transient cracking mode the heating element duty may be varied in correspondence to the reaction feed load and/or the process gas temperature at the outlet of the reaction tube.

In the context of the invention, “first” and “second” modes of operation may refer to general modes of operation of the reactor arrangement or the reactor vessel. These may include (i) one or more modes with or without a gas flow through the reaction tubes, (ii) one or more modes in which a hydrocarbon containing mixture is passed through the reaction tubes, in particular in a cracking operation of a reactor arrangement set up for steam cracking, (iii) one or more modes in which steam is passed through the reaction tubes in standby operation, (iv) one or more modes in which an air containing mixture is passed through the reaction tubes, in particular for decoking, or (v) one or more modes including other start-up and shutdown operations with a gas flow, in particular with nitrogen, air or similar “start-up media”. Such modes may also be specified, for example, on the basis of a detected runtime of the reactor arrangement or of a reactor vessel after a specified event, for example since the last decoking cycle.

Whether a first or second mode of operation is active or carried out can alternatively or additionally also be specified on the basis of instantaneous measurement data, such as those obtained on the basis of temperature measurements in the area of the heating elements, temperature measurements in or on the reaction tubes, or temperature measurements of a process gas at the outlet of the reaction tubes. Correspondingly, it is also possible to obtain, for example, current quantity measurements, in particular in the feed lines to the reaction tubes (for recording the flow rate and the current composition), oxygen measurements in the reactor vessel and/or in a connected stack or and/or exiting stack, pressure measurements in the reactor vessel, analytical measurements downstream of the outlet of the reaction tubes (to determine the composition of the products and, on this basis, for example a gap sharpness), measured values of heating powers, applied electrical voltages and/or current strengths, and pressure measurements upstream and/or downstream of the reaction tubes or pressure difference measurements across the reaction tubes can be used.

In embodiments, the invention may comprise, as will be further explained below, any process controls. These may, in particular, be (i) based on or for setting temperature setpoints (e.g., a process gas temperature at the outlet of the reaction tubes), (ii) specifications for stream quantity controls, in particular in feed lines to the reaction tubes (for determining the flow rate and the current composition), (iii) setpoints for heating powers, applied electrical voltages and/or current intensities, and (iv) setpoints for heating rates or cooling rates. At all times, a temporal evaluation of acquired measurement data or setpoints can be performed and taken into account accordingly, and temporal rates of change of a measured value (e.g., averaged rate of change over a certain period of time) can be determined and a quantification of the temporal variability of a measured value (e.g., via an acquisition of the standard deviation of a measured value over a certain period of time) can be performed. By using a temporal rate of change averaged over a meaningful period of time may particularly result in a less noisy signal.

In the context of the invention, the reaction tubes are supplied with one or more reactants used for the chemical reaction during a reaction period or a “first” mode of operation present herein, and are not supplied with the one or more reactants during the heating period and/or during the cooling period or in other corresponding “second” modes of operation, or are fed with the one or more reactants in smaller quantities than during the reaction period. Typical reactants that are not used during second modes of operation, or are used in smaller amounts than during first modes of operation accordingly, are in particular hydrocarbons. Other reactants may include water (vapor), oxygen, and other compounds.

In the context of the invention, one or more second modes of operation may also be applied during the reaction period, preferably in sub-periods during which a load change is made, for example by changing the feed rate, product gas temperature and/or product gas composition. Such load changes are accompanied by changes in the reaction tube temperature level as well as changes in the current or power input to the heating elements, which in turn result in changes in the heating element temperatures.

According to the invention, at least in a portion of the reactor vessel in which the one or more heating elements are arranged, a gas atmosphere is provided.

The gas atmosphere provided in at least a part of the reactor vessel in which the one or more heating elements are provided is particularly separated from the one or more reactants which are supplied to the reaction tubes by walls of the reaction tubes. In other words, the oxygen content adjusted according to the invention particularly concerns a “gas space” of the reactor, i.e. the gas atmosphere does not come into contact with the process gas passed through the reaction tubes comprising the one or more reactants, except in the case of a coil rupture. However, this gas space is in direct contact with the outer surface of the heating elements, as well as with the outer surface of the walls of the gas-tight reaction tubes. The gas atmosphere, therefore, surrounds the reaction tubes but is not provided within them.

The second mode of operation may be a decoking operation, as mentioned, in which a decoking gas stream, such as a mixture of air as steam, is passed through the reaction tubes. The oxygen content of the gas atmosphere provided in at least a part of the reactor vessel in which the one or more heating elements are provided is particularly independently adjusted from an oxygen content of the decoking gas stream. This may, however, include that a simultaneous or timely related increase of the in the gas space outside the reaction tubes is performed.

According to embodiments of the invention, an amount of the radiant heat supplied to the reaction tubes by means of one or more electric heating elements in the reactor vessel may amount to more than 90% of, particularly the whole of, a total amount of heat supplied to the reaction tubes in the reactor vessel. That is, according to such embodiments of the invention, the reactor does not contain any (additional) firing besides the electrical heating, or such firing contributes only a minor amount of heat supplies to the reaction tubes.

Therefore, in such embodiments, the oxygen content to be set in the gas space outside the reaction tubes has no noticeable influence on the heat input into the reaction tubes. The oxygen control is thus used exclusively for safety and service life protection and not for process control. Also, the energy consumption of the electric furnace is not influenced by the oxygen content, in contrast to a fired furnace where the temperature of the combustion chamber is influenced by the oxygen content and thus also the heat input into the reaction tubes. It should also be mentioned that the oxygen content in the coil box has no significant influence on pollutant emissions during regular operation of the electric furnace. Only ageing processes on the surfaces of the heating elements are influenced, where ageing refers to slow reactions with very low conversion rates.

The gas atmosphere comprises, in particular in addition to one or more known inert gases such as nitrogen or carbon dioxide or one or more noble gases, a content in oxygen, which, according to the invention, is being dynamically adjusted during operation to result in time-variable, predetermined oxygen volume fraction values and/or value ranges. According to the invention, this is done in such a way that the volume fraction of oxygen during the one or more first modes of operation is adjusted between a first limit value and a second limit value, the first limit value being between a 500 ppm and a 0.5% volume fraction, and the second limit value being above the first limit value and between a 3% and a 10% volume fraction. The first limit value may also be between a 500 ppm and a 0.1% volume fraction, between a 0.1% volume fraction and a 0.2% volume fraction, between a 0.2% volume fraction and a 0.3% volume fraction, between a 0.3% volume fraction and a 0.4% volume fraction, and between a 0.4% volume fraction and a 0.5% volume fraction, or any contiguous combination of two or more of these ranges. The second limit value may also be between a 3% and a 4% volume fraction, between a 4% and a 5% volume fraction, between a 5% and a 6% volume fraction, between a 6% and a 7% volume fraction, between a 7% and a 8% volume fraction, between a 8% and a 9% volume fraction, between a 9% and a 10% volume fraction, or any contiguous combination of two or more of these ranges.

During the one or more second modes of operation, the volume fraction of oxygen is set, according to the invention, at least on a time-average basis (in the sense explained above) to a higher value than in the one or more first modes of operation. Herein, the lower value may be used to define a lower threshold and the upper value may be used to define an upper threshold for a (feed-back) control structure implemented in a control device or system adjusting the oxygen volume fraction.

In particular, the volume fraction of oxygen may be adjusted within the scope of the invention during the one or more second operating modes between a third limit value and a fourth limit value, wherein the third limit value is above the first limit value and the fourth limit value is above the second limit value and/or wherein the third limit value is above the second limit value. The third and/or fourth limit value may be changed during the one or more second modes of operation, particularly over time. Thus, a corresponding threshold-based setting can also be made for the (higher) oxygen content during the one or more second operating modes, wherein the specifically set value can also be changed continuously or stepwise during the one or more second operating modes, in order to correspond, for example, to a gradual increase in the temperature and/or to the gradual increase in a reactant feed.

In general, within the scope of the invention, subject to the limitations explained above, a maximum content of oxygen may be specified, in particular, at or below an atmospheric oxygen content, i.e., in particular, below 20, 15, or 10% by volume. The time-averaged oxygen content at one or more locations within the reactor vessel in the one or more second modes is in particular more than 0.1, 0.5, 1, 2 or 5 percentage points higher than in the one or more first modes. Preferably, in a transient cracking operation or generally any other second mode of operation with flammable gas components fed to the reaction tubes, the time-averaged oxygen content at one or more locations within the reactor vessel is between 0.1 and 5 percentage points or between 0.5 and 2 percentage points higher than in the one or more first modes of operation, but stays below the atmospheric oxygen content or below a lower, safety-oriented maximum oxygen content. Preferably, in steam standby operation, decoking operation or generally any other second mode of operation without flammable gas components fed to the reaction tubes, the time-averaged oxygen content at one or more locations within the reactor vessel is more than 1, 2 or 5 percentage points higher than in the one or more first modes of operation and may be increased until the atmospheric oxygen content level.

By maintaining an oxygen content between variable limit values according to embodiments of the invention, the durability of corresponding heating elements can be increased on the one hand and a high level of operational safety can be ensured on the other. The comparatively lower oxygen content during the one or more first operating modes ensures that the formation of a critical (ignitable or explosive) atmosphere in the reactor vessel is reliably prevented or the burnup is limited even if reactants escape from the reaction tubes. By using the comparatively higher oxygen content during the one or more second operating modes, the particularly high susceptibility of the heating elements to damage of protective oxide layers on the surface of the heating elements due to thermal expansion effects during these phases is reliably avoided, or defects occurring in the oxide layer can be repaired more quickly by improved availability of oxygen in the atmosphere through reoxidation.

Providing the possibility of a time-variable oxygen control maximizes on the one hand the durability of the heating elements and guarantees on the other hand an always safe operation. Thus, within the scope of the invention, various possibilities for dynamic atmospheric conditioning can be implemented that meet the above requirements. In particular, a dynamic control may include dynamically adjusting the lower and/or upper limits of the oxygen content of the gas atmosphere inside the reactor vessel, depending on the instantaneous operating mode (in the first or second operating mode(s)) and on the operating condition. During this adjustment, both the lower/upper shutdown limit values, alarm limit values, process switching values (especially in the case of floating control) and/or process setpoint values (in the case of continuous control) can be changed.

The heating elements used for indirect heating of corresponding reaction tubes typically comprise electrically conductive, metallic or non-metallic heating structures in a given shape of, for example, straight or otherwise shaped rods, wires or strips, wherein the metallic heating structures can preferably be formed in particular from an alloy containing at least the elements Fc, Cr and Al. Alternatively or additionally, metallic heating structures can also be formed at least partially from nickel-chromium alloys, copper-nickel alloys or nickel-iron alloys.

It has been found that for the indirect heating of reaction tubes, especially in steam cracking, extremely high heat flux densities at high temperatures are required for economical operation, so that the heating elements or the heating structures must be operated near their upper temperature limit. However, it is precisely near this limit that the heating elements and heating structures are highly sensitive to the furnace atmosphere. In particular, a certain minimum oxygen content is advantageous in order to avoid or slow down rapid or gradual deterioration of the heating elements or the heating structures. For example, when using metallic heating structures containing aluminum, a stable aluminum oxide layer forming on the surface of the heating structures, which protects the material from uncontrolled corrosion and other damage mechanisms, can be maintained. The invention therefore effects a long durability of the heating elements or of their heating structures by using an appropriate minimum oxygen content.

It has been found that FeCrAl based heating elements are damaged by exposure to atmospheres containing high concentrations of nitrogen and low concentrations of oxygen at high temperatures and thus have lower maximum operating temperatures in such atmospheres compared with their permitted maximum operating temperatures in air. Without being bound by theory, this damage is thought related to the formation of nitrides which interferes with the formation of the protective aluminium oxide layer on the element surface and causes corrosion which can significantly reduce heating element life. The degree and speed at which such damage can occur relates to the concentration of oxygen and oxygen containing species in the atmosphere in contact with the heating element as well as the element temperature. For example, research as documented in J. Min. Metall. B 55, 2019, 55, has shown that heating FeCrAl material to 1,200° C. in an atmosphere of 99.996% nitrogen (impurity level of oxygen and water below 10 ppm) resulted in a progression of corrosion which takes place through the formation of localized subsurface nitridation regions composed of AlN phase particles. Conversely, as documented in Surf. Coat. Technol. 135, 2001, 291, for FeCrAl alloys no significant morphological differences among the oxide scales obtained by oxidation in air or in gaseous atmospheres containing 2 or 10% vol. of oxygen were observed.

Again, without being bound by theory and not limiting the scope of the invention, the oxygen concentration required at the surface of the heating element to prevent accelerated deterioration of the element is believed to depend on operating conditions such as temperature, as well as the thermal history of the heating element, which determines the thickness and quality of any protective oxide layer. While a quite low oxygen concentration (e.g., 100 ppm) may suffice to prevent accelerated deterioration in favourable circumstances, it is prudent to target a higher oxygen concentration in the furnace atmosphere, to account for situations in which the heating element surface is more vulnerable to nitridation and also to account for a non-uniform distribution of oxygen through the furnace, which may result in its concentration being locally below the targeted concentration. Therefore, a practical lower limit to the oxygen concentration in the furnace or reactor vessel atmosphere appears to be 0.1% oxygen by volume, but also 500 ppm may be selected. Higher limit concentration values, such as 0.2% oxygen by volume or more, such as 0.5% or 1% by volume, may provide an additional margin of safety at less favourable furnace conditions or more pronounced maldistribution of oxygen, and may be selected in accordance with this invention. Conversely, as long as a minimum oxygen concentration to prevent nitride corrosion is satisfied, low oxygen concentration in the vicinity of the heating elements may be beneficial, as it is known that the rate of oxidation of typical heating element materials increases with the oxygen concentration. The minimum oxygen concentration may depend on the temperature and also the composition of the heating elements.

Given the complexity of the underlying physical mechanisms and the wide range of operating conditions in such a furnace, it is of particular interest to foresee the possibility of a time-variable oxygen control, and to adapt the atmosphere conditioning as required according to the invention.

The provision of the gas atmosphere provided according to the invention is advantageous in connection with the metallic alloys mentioned, but also in principle for use in connection with other materials, for example based on MoSi₂ or SiC, irrespective of the damage effect to be observed in each case.

An important consideration in determining the maximum amount of oxygen allowed is the flammability limits of the feed and product gases. On the flammability envelope of all combustible gases there is an oxygen concentration, commonly referred to as the Limiting Oxygen Concentration (LOC), below which a flammable mixture cannot be formed. For example, the LOC of ethylene at 25° C. and 1 atm is 10% oxygen. At these conditions, any mixture of ethylene, nitrogen, and oxygen that does not contain at least 10% oxygen cannot generate a self-propagating flame. Combining literature data with a temperature adjustment procedure, the LOCs of ethane and ethylene at a typical steam cracking temperature of 830° C. can be estimated to be 4.1% and 3.6%, respectively. If the oxygen concentration in the reactor vessel is such that it is lower than these limits, a flammable mixture will not be formed in the event of a coil rupture.

While there are some uncertainties to calculate the same limit for a complex mixture like naphtha, estimates include 4.2% for the LOC for hexane, so ethylene is expected to be the reactant/product with the lowest LOC. While 830° C. is above the autoignition temperature of all of these hydrocarbons, even if there is spontaneous combustion, staying below the LOC is expected to prevent a shockwave from forming.

On the basis of these observations, the oxygen levels for the first and second operation modes according to the invention may be selected for any operation mode during which flammable components are fed to the process tubes. It shall further be noted, that for one or more of the second operation modes during which no flammable components are fed to the process tubes, the maximum oxygen level may be temporarily raised up to atmospheric levels.

In general, the heating elements used in the context of the invention can have a base body formed, for example, from an electrically non-conductive, heat-resistant material (e.g. ceramic), on or in which the heating structures, for example in the form of heating wires or heating ribbons, are guided e.g. in a meandering manner. Alternatively, one or more straight and/or curved heating structures with a holder associated with the heating element can also be used. For example, so-called heating cartridges can be used, which can be fixed in suitable connections by means of plug-in or bayonet connections and the like. Typically, a multiphase alternating current (AC), in particular a three-phase alternating current, is used for heating, and the heating wires can be connected in groups to the phases of a corresponding alternating current, but also direct current (DC) heating may be used. The invention permits any grouping, arrangement, and mode of operation of corresponding heating elements and is not limited thereby.

By the use of the invention, i.e. the use of comparatively higher oxygen contents in particular during the heating and/or cooling periods or corresponding other “second” operating modes, excessive ageing of the heating elements can be reliably avoided even during corresponding heating and/or cooling or in other operating modes which are (more) susceptible to this. During heating, for example, cracks can occur in the latter in particular due to the different thermal expansion of the metallic base material of the heating elements and the protective oxide layer formed thereon. The formation of such cracks can be counteracted by a higher oxygen content, facilitating the fast regeneration of an intact protective oxide layer. At the same time, it is of less importance to ensure a low-oxygen atmosphere in the reactor vessel during a corresponding heating-up period in which the reaction tubes are fed, for example, with steam but not yet with flammable reactants such as hydrocarbons. The invention takes this into account.

Before feeding in the above-mentioned (in particular flammable) reactants, especially hydrocarbons, the heating elements can thus be brought to elevated temperatures in a corresponding heating-up period, during which a comparatively high oxygen content can still be maintained. The oxygen setpoint can then be reduced continuously or stepwise down to a sufficiently low level permitting the reactant feed to be started. When stable operation is achieved, a further reduction may be made.

In one embodiment of the invention featuring multiple, separately controllable conditioning gas injection points, the latter reduction can be achieved, for example, by adjusting a premix ratio at the injection points close to the wall, so that the content in the region of the reaction tubes remains virtually unchanged. During cooling after the reaction operation, the oxygen content in the reaction vessel can be increased accordingly in a reversed procedure.

As mentioned, a continuous or stepwise change in the volume fraction of oxygen can be made during the one or more second modes of operation, and the volume fraction of oxygen can be adjusted during the one or more second modes of operation as a function of the reaction tube temperature, a temperature of the heater(s), and/or an amount of the reactant(s) fed into the reaction tubes, and in particular can be modified continuously or stepwise. In this way, the previously mentioned objectives (avoidance of damage to the heating elements and avoidance of an explosive atmosphere, for example) can always be achieved to the greatest possible extent within the scope of the invention.

As mentioned, during the one or more first modes of operation, the reaction tubes may be maintained at a reaction tube temperature level in at least one section such that the reaction tube temperature level in this section changes only within a predetermined range, in particular by no more than 10 K, 30 K, 50 K. The heating elements may also be energized during the one or more first modes of operation in particular at a constant or substantially constant effective current, wherein a substantially constant current is intended to denote here an operation with a power consumption that varies by no more than 5%, 10%, 30% during the one or more first modes of operation. Power consumption is here preferably understood as an effective power consumption averaged over time periods of minimum 10 s, 30 s, 1 min, or 5 min, to filter out any short-term fluctuations linked in particular to power control operations (e.g. burst-control or phase angle control in a thyristor).

The reaction tube temperature, on the other hand, can be significantly varied in the one or more second operating modes, e.g. in heating or cooling periods. In heating periods, the reaction tube can be heated starting from an initial temperature level in a range of, for example, −50 to 700° C. to a final temperature level in a range of, for example, 500° C. to 1,200° C., and vice-versa during a cooling period. The temperatures of the heating elements also change accordingly, with an initial temperature level during a heating period here also being, for example, −50 to 700° C. and a final temperature level here being, for example, 600 to 1400° C. In all cases, according to the invention, special consideration can be given to this by using the different oxygen contents. Such heating periods may be executed with or without conducting electric current through one or more of the heating elements installed in the furnace. For instance, an initial heating phase may be done solely by a flow of an externally preheated medium, e.g. steam, air and/or nitrogen, through the reaction tubes in the furnace. Alternatively, the furnace may at least partially be heated up by applying electric current to one or more of the heating elements but without any fluid flow passing through the reaction tubes. In a preferred embodiment, at least part of the heating period comprises to have a flow of an externally preheated medium, e.g. steam, air, nitrogen and/or hydrocarbons, and to simultaneously apply an electric current to one or more of the heating elements, thereby gradually increasing the temperature in at least a part of the furnace. Cooling periods may be operated in analogous manner by varying composition, flow rate and/or preheat temperature of the fluid media passed through the reaction tubes and/or varying the electric current passed through one or more of the heating elements in the furnace.

In a more general formulation, the volume fraction of oxygen may be at least temporarily or intermittently varied during the one or more second modes of operation, while simultaneously the second mass flow rate of the one or more reactants may be at least intermittently varied, and/or the second radiant heat flux may be at least intermittently varied during the one or more second modes of operation. The term “intermittent(ly)” shall refer to a variation which does not necessarily take place during the whole time a corresponding operation mode is performed but may be intercepted by periods of non-variation. The at least intermittent variation of the volume fraction of oxygen during the one or more second modes of operation may be performed (at least) taking into account the at least intermittent variation of the second volume flow of the one or more reactants and/or taking into account the at least intermittent variation of the second heat flux of the radiant heat during the one or more second modes of operation. Further embodiments and criteria for performing the first and second modes of operation have already been explained.

As also explained above in other words, at least a portion of each of the reaction tubes may be maintained at a reaction tube temperature in a first temperature range during the one or more first modes of operation and at a reaction tube temperature in a second temperature range during the one or more second modes of operation. The first temperature range may be, in particular, 400 to 1,500° C., and further in particular, 450° C. to 1,300° C., 500° C. to 1,200° C., or 600° C. and 1,100° C., particularly at a reaction tube surface and/or within the reaction tubes. The second temperature range is defined, for example, by a temperature difference with respect to the first temperature range, in particular a temperature difference of at least 1 K, 10 K, 50 K or 100 K. In some cases, this difference can also be small, e.g. near the inlet of a reaction tube. In some cases, the difference may also be locally negative, for example when an elevated inlet temperature is used in a second mode of operation. As mentioned, the second temperature range can also be achieved in particular by an appropriate standby operation with pure steam flow.

In the context of the invention, corresponding heating elements can be arranged in particular on the walls of the reactor vessel and radiate heat from there to the reaction tubes. The walls may be straight or curved, e.g. in the form of parabolic surfaces. The walls can have a combination of any wall shapes and also, for example, straight wall sections that can be arranged at an angle or at any angle to one another. The provision of the gas atmosphere according to the invention ensures that the oxygen contents mentioned prevail in the areas where the heating elements are arranged.

The invention results in increased operational safety for corresponding reactor vessels due to the proposed adjustment of the upper oxygen limit during the one or more first modes of operation, in particular in the event of damage to the reaction tubes (“coil ruptures”). In the event of corresponding damage, one or more reaction tubes can be severed, in particular completely; however, the invention is also advantageous for leakages on a smaller scale. In the event of corresponding damage, there is a sudden or gradual escape of combustible gas into the reactor vessel, which is largely sealed off for thermal insulation reasons.

Such damage is less of a safety problem in conventional fired reactors than in arrangements according to the invention, in which at least one reactor vessel is heated exclusively electrically, since in fired reactors combustible gases escaping from the reaction tubes, for example in the form of a hydrocarbon/steam mixture, can be converted in a controlled manner by the combustion taking place in the reactor vessel or in a corresponding combustion chamber, or can be safely discharged in the exhaust gas flow. Furthermore, since the combustion of fuel gas, which is already taking place in a regular manner, results in a significantly reduced oxygen content, the gas chamber surrounding the reaction tubes is thus already essentially “inertized”. In contrast, in the case of purely electrical heating, corresponding combustible gases could accumulate in the reactor vessel and reach the explosion or detonation limit there at the normal oxygen content of the air and temperatures above the auto-ignition temperature, for example. Even in the case of combustion without explosion or detonation, complete or incomplete combustion results in an energy release and thus possibly in overheating. Complete or incomplete combustion, together with the volume of gas flowing out of the reaction tubes, can lead in particular to an undesirable increase in pressure. The invention reduces such an increase in pressure because the burnup of the gas mixture is limited by the low oxygen concentration, and therefore, the low oxygen inventory, in the reactor chamber.

Thus, the invention is particularly preferred for indirectly electrically heated reactors in which the process gas temperature is close to or above the auto-ignition temperature of components contained in the process gas, particularly hydrocarbons.

By means of the proposed measures, the invention creates a containment with a conditioned atmosphere which serves for the maintenance of a protective oxide surface on the heating elements and for the safety-related protection of high-temperature reactors in which the energy input takes place electrically. In particular, the use of the invention also results in improved durability of the heating elements, which are particularly protected by the higher oxygen content during heating and cooling, during load changes, or during decoking or standby periods. Within the scope of the invention, in this way, in particular, a completely electrical heating of the correspondingly operated reactor vessel may be provided, i.e. the heating of the reaction tubes, at least within this reactor vessel, is advantageously carried out predominantly or exclusively by electrical heating, i.e. at least 90, 95 or 99% of the heat quantity introduced here, in particular of the entire heat quantity introduced here, is carried out by electrical heating means. Heat input via a gas mixture passed through the one or more reaction tubes is not taken into account here, so that this proportion relates in particular to the heat transferred inside the reactor vessel from outside to the wall of the one or more reaction tubes or generated inside the reactor vessel in the wall or a catalyst bed.

In certain embodiments of the invention, hereinafter also referred to as the “first group of embodiments”, one or more gases or gas mixtures used to provide the gas atmosphere can be fed into the reactor vessel during the one or more first modes of operation and/or during the one or more second modes of operation or during any phases thereof, while at the same time a part of the gas atmosphere is exported from the reactor vessel. This results in particular in a continuous flow through the reactor vessel, so that in this way also, for example, a heat accumulation or a local enrichment or depletion of gaseous components can be avoided. In this way, it is particularly easy to control the oxygen content in the gas atmosphere by adjusting the feed accordingly.

In this first group of embodiments, one or more outflow openings (hereinafter the singular is used in part only for simplification) from the reactor vessel, which in particular can establish a connection with a stack, for example an (emergency) stack, is or are permanently open during the one or more first modes of operation and/or during the one or more second modes of operation or during any phases thereof. By this is meant that the one or more outflow openings do not oppose any mechanical resistance to the outflow or inflow of fluid into or out of the reactor vessel, except for the possibly existing constriction of the flow cross-section. Thus, the one or more openings is or are unsealed at least during the reaction period.

In this case, a stack opening or a connection to the stack or another outflow opening also serves to discharge excess gas or, in particular, combustible hydrocarbons in the event of damage to the reaction tubes. In this case, a stack can have constructive elements (so-called velocity seals or confusers), especially in the area of the stack wall, to prevent backflows (e.g. due to free convection currents) back to the reactor vessel.

In other embodiments, hereinafter also referred to as the “second group of embodiments”, an outflow opening or several outflow openings from the reactor vessel (hereinafter the singular is used in part only for simplification), in particular a stack opening or a connection to the stack, can be designed to open only above a predetermined pressure level, for example by closing the outflow opening via a pressure flap or a bursting disc or corresponding valves. In this case, the outflow opening is normally closed, i.e. below the predetermined pressure level, but serves for the discharge of excess gas or, in particular, combustible hydrocarbons in the event of damage to the reaction tubes, in the event of a corresponding pressure increase by the release of a corresponding stack cross-section. In this case, an intermittent or permanent opening can be provided when the predetermined pressure level is reached. In this context, a “permanent” opening is understood to mean, in particular, an irreversible opening, so that in this embodiment no resealing takes place after the pressure subsequently falls below the predetermined pressure level by releasing gas. In the case of an “intermittent” opening, on the other hand, a reclosure may take place.

For opening at the predetermined pressure level, the one or more outflow openings can, for example, have one or more spring-loaded or load-loaded flaps which have an opening resistance defined by the spring or load characteristics and therefore only open at a corresponding pressure or, more precisely, a pressure differential across the opening. For possible embodiments, reference is made to International patent application PCT/EP2022/059330 for example, particularly to FIGS. 6A to 6D and the corresponding explanations at page 28 which are incorporated herein by reference to the extent possible by law. In addition to the aforementioned use of bursting discs or (mechanical) pressure relief valves known per se, it is also possible to detect a pressure value, for example by sensor, and to trigger an opening mechanism of any type, for example an ignition mechanism or an electro-actuator drive, when a predefined threshold value is exceeded. This makes it possible to create an opening with a sufficiently large cross-section within a short response time if necessary, which is kept closed in the explained manner during normal operation.

In this case, i.e. in the second group of embodiments, the stack opening, which is closed during normal operation, can be bypassed via a corresponding bypass line opening into the stack in order to remove the gas atmosphere or to flush the reactor vessel. In this way, by using fluid-technical devices in the bypass line, a particularly controlled and, for example, time-controlled withdrawal is possible.

Generally, withdrawal of gas from the reactor chamber is possible to effect a change in the composition of the gas atmosphere and/or a cooling. Gas withdrawn from the reactor chamber can be cooled and/or regenerated in order to be used again (recycled) for providing the gas atmosphere. In the course of cooling, a heat integration can be performed, i.e., particularly in a heat exchanger, heat withdrawn from the gas may be transferred to a further stream and/or steam in a steam system.

For feeding the one or more gases or gas mixtures used to provide the gas atmosphere during the one or more first modes of operation and/or during the one or more second modes of operation or during any phases thereof, gas feed means provided in particular in the form of feed nozzles or feed openings or comprising such means can be provided and used, as well as a gas reservoir connected thereto. These can in particular be designed to be controllable by known means of fluid technology.

The feed and/or extraction can be carried out continuously or discontinuously, in particular in accordance with a control based on a desired oxygen content to comply with the first and second limit values used in accordance with the invention and/or any other setpoint or limit values, for example the third and fourth limit values used in one embodiment of the invention.

In other words, in the context of the invention, during the one or more first modes of operation and/or during the one or more second modes of operation or during any phases thereof, a continuous or discontinuous feed of one or more gases or gas mixtures used to provide the gaseous atmosphere may be made into the reactor vessel, and a withdrawal of at least part of the gas atmosphere from the reactor vessel may further be made, wherein the withdrawal may be made at least partially simultaneously with or at least partially delayed from the feed.

Within the scope of the invention, a sub-atmospheric pressure level can be provided in the reactor vessel during the one or more first modes of operation and/or during the one or more second modes of operation or during any phases thereof. This can be brought about, in particular, in the case of simultaneous feed and withdrawal in the manner explained and, in particular, by coordinating the feed and withdrawal in the case of an embodiment having a permanently open connection from the reactor vessel to the (emergency) stack or other measures previously provided in connection with the first group of embodiments. In this case, due to the high temperatures in the stack and reactor vessel and the resulting lower density of the contained gas volume, a static negative pressure results in the reactor vessel. The use of (“sucking”) fans inducing a draft, for example until a corresponding static negative pressure is formed, can also be provided in this context.

By operating the reactor vessel at a subatmospheric pressure level during the one or more first modes of operation and/or during the one or more second modes of operation or during any phases thereof, an outflow of possibly harmful, corrosive or combustible undesirable components from the reactor vessel can always be reliably prevented. However, an inflow of air or secondary air may occur, but this can be limited by a sufficiently tight design and/or compensated for by appropriate control.

Consequently, when operating the reactor vessel at a subatmospheric pressure level, the walls of the reactor vessel are preferably provided in a particularly high gas tightness to prevent uncontrolled air and therefore oxygen ingress into the reactor vessel. In an embodiment, the furnace walls are built such that the relative air ingress rate per furnace inner wall surface area and per average pressure difference (as an absolute value) between the reactor vessel interior and the surrounding outside atmosphere (at same altitude) is limited to values below 0.5 Nm³/(h×m²×mbar), below 0.25 Nm³/(h×m²×mbar) or below 0.1 Nm³/(h×m²×mbar), where Nm³ are normal cubic metres at 0° C. and standard atmospheric pressure. The furnace inner wall surface area is defined here as the sum of the hot surface areas of the thermal box or reactor vessel insulation delimiting the inner box volume in all directions (i.e. on the sides, top and bottom), without including the surface area of radiative heating elements or other structures protruding from the thermal insulation into the inner box volume. These values are selected such as to enable moderate inert gas feed rates (to minimize utility consumption and convective heat losses through the stack) while maintaining the resulting oxygen concentration in the reactor vessel interior below the defined upper limit. In a preferred embodiment, the average pressure difference (as an absolute value) between the reactor vessel interior and the surrounding outside atmosphere (at same altitude) is below 10 mbar, below 5 mbar or below 3 mbar, depending mostly on the stack design (e.g. height, diameter, insulation) and the optional provision of fans or similar devices. As general design rules, the tightness of the reactor vessel walls is preferentially increased when a lower value of the upper oxygen limit is defined and/or when operating costs are to be minimized and/or when the absolute pressure difference over the walls of the reactor vessel toward the environment is increased.

In an alternative, however, which may be used in particular in connection with the aforementioned second group of embodiments, a superatmospheric pressure level can also be set in the reactor vessel during the one or more first modes of operation and/or during the one or more second modes of operation or during any phases thereof. Thus, a superatmospheric pressure level can preferably be provided if a stack opening to the reactor vessel is closed or formed for an opening only above a predetermined pressure level, as explained.

In particular, the gas atmosphere can be provided by feeding one or more gases or gas mixtures used to provide the gas atmosphere into the reactor vessel without, however, simultaneously removing part of the gas atmosphere from the reactor vessel, as in the embodiment just explained. In this case, corresponding gases or gas mixtures can be fed up to a superatmospheric pressure level which, however, is below an opening pressure of the mentioned and above explained outflow openings. A corresponding design enables in particular a reduction of the required gas quantities, since advantageously the gas atmosphere can be fed in only at the beginning or intermittently during the reaction phase and then maintained without further measures.

However, a superatmospheric pressure level can also be set during the one or more first operating modes and/or during the one or more second operating modes or during any phases thereof, in an embodiment with feed of gases or gas mixtures to provide the gas atmosphere and simultaneous withdrawal of part of the gas atmosphere from the reactor vessel, preferably by providing an appropriately controlled and/or dimensioned bypass line which ensures a corresponding pressure level in the reactor vessel. Reference is made to the above explanations. In other words, a superatmospheric pressure level can be set in the reactor vessel even with a permanently open outflow opening or, for example, an outflow opening with adjustable flow rate, if the gas quantity fed in and/or the gas quantity flowing out via the outflow opening is adjusted accordingly.

If a superatmospheric pressure level is provided in the reactor vessel, in particular by a controlled feed, in the reactor vessel during the one or more first modes of operation and/or during the one or more second modes of operation or during any phases thereof, an inflow of outside air which increases the oxygen content in an uncontrolled manner can be prevented. In this embodiment, a measurement of the oxygen content may be unnecessary since there is no possibility of subsequent increase.

Herein, the term “subatmospheric pressure level” shall refer to any pressure below the local barometric pressure prevailing at the considered time of operation at a nearby ambient location around the furnace, particularly at least 1, 3, 5, 10, 50 or 100 mbar below this barometric pressure. Correspondingly, the term “superatmospheric pressure level” shall refer to any pressure above the local barometric pressure prevailing at the considered time of operation at a nearby ambient location around the furnace, particularly at least 1, 3, 5, 10, 50 or 100 mbar above this barometric pressure.

In embodiments of the invention, a wall of the reactor vessel does not comprise inspection ports for visual inspection of an inner space of the reactor vessel that are open to the atmosphere, or only comprises inspection ports for visual inspection of the inner space of the reactor vessel which are gas-tightly closed by a transparent material, particularly a heat-resistant transparent material. That is, in embodiments of the invention, particularly no heat and/or gas leaks are provided in the reactor walls in the form of (open) inspection ports, such that the gas atmosphere in the reactor may be adjusted in a particularly controlled manner. In embodiments, glazed and scaled viewing windows, i.e. inspection ports for visual inspection of the inner space of the reactor vessel which are gas-tightly closed by a transparent material are provided. The windows are preferably equipped on the outside with movable heat-insulated covers or blinds, which limit heat losses when the windows are not used for observation. In embodiments of the invention, cameras may be provided which allow observation of the reaction tubes but are installed in a way that a gas-tight seal is maintained, i.e. behind transparent windows or inside the reactor. In the latter case, any cabling may be passed through the reactor wall through gas tight ports.

In embodiments of the invention, open ports in the wall of the reactor may be dispensed with particularly because electrical heating reduces or obviates the need of monitoring the temperatures of the reaction tubes because heat is provided in a much more controlled manner in comparison to burners.

Recapitulating the above explanations, the gas atmosphere may be provided during the one or more first modes of operation and/or during the one or more second modes of operation, or during any phases thereof, by injecting one or more gases or gas mixtures used to provide the gas atmosphere into the reactor vessel without performing a simultaneous withdrawal of a portion of the gas atmosphere from the reactor vessel or while performing a simultaneous withdrawal of a portion of the gas atmosphere from the reactor vessel.

Merely for the sake of clarification, it should be emphasized once again that operation at a sub-atmospheric pressure level can be carried out in particular if there is a (comparatively) large-area connection (i.e. low flow-related pressure loss) between the reactor vessel and a stack outlet and a sufficiently high stack is filled with hot (i.e. light) gas. In this case, the flow-induced pressure drop is less than the geodetic pressure difference between hot gas and cold outside air that results over the height of the stack, resulting in a negative pressure difference between the inside gas atmosphere and the outside atmosphere at the same geodetic height. Also, as mentioned, a fan can be used to provide a sub-atmospheric pressure level. A fan can be provided in the main stack line as well as in a bypass line.

Conversely, a superatmospheric pressure level results in particular if the connection between the reactor vessel and the stack outlet (during regular operation) is completely closed or reduced in size, for example via a bypass line, in such a way that the pressure loss is greater than the geodetic pressure difference between hot gas and cold outside air resulting over the height of the stack or the bypass line.

Thus, in the first and second groups of embodiments, the invention can be carried out with a subatmospheric or superatmospheric pressure level in the reactor vessel during the one or more first modes of operation and/or during the one or more second modes of operation or during any phases thereof. In the first group of embodiments, a sub-atmospheric pressure level can also be provided by appropriately dimensioning the outlet openings and/or using a fan.

According to a particularly advantageous embodiment, the process according to the invention comprises using, during the one or more first modes of operation and/or during the one or more second modes of operation or during any phases thereof, a plurality of gases or gas mixtures to provide the gas atmosphere, comprising a first gas or gas mixture having a first volume fraction of oxygen and a second gas or gas mixture with a second volume fraction of oxygen below the first volume fraction. These can be used as explained below.

In one embodiment of the invention, it can be provided that during the one or more first modes of operation and/or during the one or more second modes of operation or during any phases thereof, at least part of the first gas or gas mixture is fed into at least a first region of the reactor vessel, whereas at least part of the second gas or gas mixture is fed separately therefrom into at least one second region of the reactor vessel. This embodiment makes it possible, in particular, to adjust the spatial distribution of the oxygen content in a particularly advantageous manner depending on local requirements. It can also be provided that the feed into the first and second areas takes place simultaneously, and in particular also in adjustable quantities in each case, or not simultaneously. For example, at least intermittently, the gas or gas mixture can be fed into only one of the areas, for example if at a subatmospheric pressure level an air intake (and thus the inflow of oxygen) is so high that only nitrogen or another inert gas is to be fed in. A defined air intake can also be ensured during the one or more first modes of operation and/or during the one or more second modes of operation or during any phases thereof, e.g. via adjustable or non-adjustable inflow openings such as ventilation slots or flaps or closable holes. Corresponding inflow openings can be designed to be openable, in particular in variable number or with adjustable flow cross-section, in order to be able to adjust the amount of inflowing ambient air in this way. A corresponding adjustment of the inflow can thereby be understood in the sense of the present invention as a further defined feed of a gas mixture, namely the ambient air.

A permanent feed of a gas or gas mixture (premixed or not, as explained below) into only one area during the one or more first modes of operation and/or during the one or more second modes of operation or during any phases thereof is also possible in this context (for example, by feed means provided only at certain points on the reactor wall, or also inlet openings for air, as just explained). A feeding “into” the corresponding area or areas is done in such a way that the corresponding gas or gas mixture (or the respective portion) reaches these area(s), for example below or laterally thereof, so that by a defined flow in the reactor vessel, due to thermal effects, or solely by an inflow impulse, the gas or gas mixture flows there. Feeding within these areas is also possible. In another embodiment of the invention, however, clean “instrument” air is used instead of air leaking into the reactor. Advantages of using clean air include that less dust, moisture, and possible contaminants which could affect element lifetimes are introduced.

In particular, the heating elements can be arranged in the at least one first area and the reaction tubes in the at least one second area of the reactor vessel. By the explained gas feed or also an intake of ambient air, in particular a relative increase of the oxygen content in the region of the heating elements (to avoid aging/damage in the explained manner) and a relative reduction of the oxygen content in the region of the reaction tubes (to minimize the reaction conversion of possibly escaping components) can be achieved.

In particular, the first and second areas are not separated from each other by separating devices of any kind, so that such an arrangement can be used in particular when corresponding first and second gases or gas mixtures can be continuously fed past the corresponding elements. A concentration gradient can be maintained by a continuous feed and withdrawal taking place in this case, whereas an intermittent feed may rather lead to a mixing over time. Therefore, this embodiment of the invention is advantageously used in the former cases.

In addition or alternatively to the embodiment with separate feed embodiment just explained, during the one or more first modes of operation and/or during the one or more second modes of operation or during any phases thereof, at least part of the first gas or gas mixture and at least part of the second gas or gas mixture can be fully or partially premixed outside the reactor vessel and fed into the reactor vessel in the fully or partially premixed state. Such an embodiment is particularly suitable for cases in which the reactor vessel does not have a continuous flow. With this alternative interconnection, concentration gradients within the large-volume reactor vessel can be minimized, particularly in the case of distributed metering at the bottom and/or side walls and/or ceiling of the reactor vessel. The advantage of a targeted oxygen enrichment in the area of the heating elements, which is possible with the previously explained design, is traded off in this case for a significantly more homogeneous distribution and a reduced risk of unfavorable local imbalances (e.g. locally too little oxygen at some heating elements or too high oxygen concentrations near the reaction tubes).

A combination of corresponding measures is also possible, for example a separate feed of premixed and non-premixed gas during the one or more first operating modes and/or during the one or more second operating modes or during any phases thereof. In this case, for example, a nitrogen-air mixture can be fed in at the wall of the reactor vessel, while nitrogen can be fed in at the center of the reactor vessel. In this way, too, moderate oxygen enrichment can be achieved in the vicinity of the heating elements and, at the same time, the concentration gradients can be limited by the partial premixing.

In principle, in the various embodiments of the invention, a feed can be made into the reactor vessel at a wide variety of locations and, in particular, at multiple points.

The first gas or gas mixture may be or comprise air, a gas mixture enriched or depleted in oxygen relative to air, or oxygen, and the second gas or gas mixture may be or comprise a gas mixture depleted in oxygen relative to air, nitrogen, carbon dioxide, or other inert gas. In principle, the first gas or gas mixture may comprise oxygen in a volume fraction greater than 1%, 5%, 10%. Known processes, for example air separation, can be used to provide corresponding gases or gas mixtures. The term “inert gas” is understood here to mean a gas which, particularly under the conditions prevailing in the reactor vessel, does not participate as an reactant in an oxidative reaction. As mentioned, only one gas or gas mixture can also be fed in, which then has in particular the composition just explained for the second gas or gas mixture.

In all cases, during and/or at the beginning and/or at the end of the one or more first modes of operation and/or the one or more second modes of operation or any phases thereof, an actual volume fraction of oxygen in at least one area of the reactor vessel can be detected and a feed of the one or more gases or gas mixtures used to provide the gas atmosphere can be regulated or controlled on the basis of the detection, in particular by a relative and/or absolute change in quantity. The detection may be carried out in particular in a predetermined cycle or (pseudo-) continuously during the one or more first modes of operation and/or during the one or more second modes of operation or during any phases thereof.

In the embodiments of the invention in which there is a continuous flow through the reactor vessel, a detection of the oxygen content can preferably be carried out downstream of the discharge from the reactor vessel (e.g. in the stack or a bypass line and the like). Additionally or alternatively, the oxygen content can be measured at one or more locations within the reactor vessel. Any suitable method of measuring oxygen content can be used e.g. tunable laser diodes, zirconium oxide probes, gas chromatography, paramagnetic, and the like.

In the case of intermittent pressurization of the reactor vessel, the oxygen content can be measured analogously in a corresponding purge gas discharge line and/or in the reactor vessel itself.

In all embodiments of the invention, during the one or more first modes of operation and/or the one or more second modes of operation or any phases thereof, if the oxygen concentration exceeds the permitted maximum level, safety relevant functions of any kind can be initiated. If the oxygen level falls below the permitted minimum level, operating measures may be initiated to re-establish the desired oxygen content in the reactor. A too low oxygen concentration is not regarded as a safety concern but can impact heating element life, as mentioned.

An impermissible escape of gas from the reaction tubes can also be detected, in particular via pressure measurement sensors in the reactor vessel. In this way, for example, an injection of reactants can be immediately prevented or halted on the basis of a corresponding switching signal.

To detect very minor damage to the reaction tubes (leakage flow without drastic or measurable pressure increase), the content of one or more reactants (especially as carbon monoxide equivalent) can also be measured continuously in the purge flow. An impermissible value can also trigger the rapid shutdown of the reactant feed.

If suitable measuring methods are used (e.g. laser, gas chromatography), the content of hydrocarbons or their combustion products, for example, can also be measured additionally or alternatively with the same sensors in the area of the reactor vessel for all the designs described.

In embodiments of the invention, leak detection may particularly be realized via the presence of moisture, as the reaction tubes typically contain significant quantities of steam.

Thus, more generally, the invention may comprise determining, based on a pressure and/or hydrocarbon measurement and/or a detection of moisture, a value indicative of a gas leak from the one or more reaction tubes, and initiating one or more safety measures when the value exceeds a predetermined threshold.

Further, in certain embodiments, the invention provides means for effecting possible preheating of the conditioning gas(es) prior to free flow into the reactor vessel. Such preheating can particularly be performed in heat exchange with gas withdrawn from the reactor chamber.

In other words, a gas or gas mixture, or at least one of two or more gases or gas mixtures, used to provide the gaseous atmosphere may be preheated during the one or more first modes of operation and/or during the one or more second modes of operation, or during any phases thereof, before being fed into the reactor vessel. Embodiments of the invention may include waste heat recovery, particularly including preheating achieved via heat exchange with gas exiting the reactor vessel.

Particularly in the case of near-wall injection of a corresponding gas or gas mixture, it can be advantageous to preheat it, e.g. by first passing it in a pipe passage over a sufficient length through the interior of the coil box, i.e. the reactor vessel, before it is then directed to an injection device. In this way, it can be avoided that an unfavorable cooling of the heating elements by a cooler conditioning gas occurs, which could possibly impair the targeted power output of the elements.

It is possible, among other things, that the injection device is located directly at the end of the heated pipe passage, or also that the heated conditioning gas is first led back out of the coil box in a pipeline (preferably in a heat-insulated pipe) and then becomes the injection device from outside. Alternatively, external heat sources can be used to preheat the conditioning gas(es) (electricity, steam, hot oil, hot water and the like).

Thus, the gas injection means used in a corresponding embodiment of the invention may comprise one or more preheating devices and one or more injection devices. An “injection” in this context is intended to refer in particular to the release of the gas or gas mixture into the reactor vessel via corresponding injection devices.

In other words, in a particularly preferred embodiment of the invention, means may be provided to transfer sensible heat in or from an interior of the reactor vessel to the corresponding gas or gas mixture.

The invention further proposes a reactor arrangement for carrying out a chemical reaction.

For further embodiments of a corresponding reactor arrangement, which may in particular be set up for carrying out a process in any of the embodiments explained above, reference is expressly made to the above explanations.

### BRIEF DESCRIPTION OF THE DRAWINGS

FIGS. 1 to 4 schematically illustrate reactor arrangements for carrying out a chemical reaction according to one embodiment of the invention.

FIG. 5 schematically illustrates modes of operation according to one embodiment of the invention.

### WRITTEN DESCRIPTION

By the proposed concept of the nearly completely sealed reactor vessel charged with a specific gas atmosphere, the oxygen content can be reduced compared to the ambient air outside. As can be exploited according to the invention, the conversion rate of the exiting hydrocarbons in case of failure of one or more of the reaction tubes and thus the additional volume expansion rate (as a result of the heat of reaction input) correlates in a first approximation with the oxygen partial pressure. This correlation is summarized in Table 1 below, where xO₂ is the oxygen mole fraction and Vᵣₑₐₖ is the reaction-related volume inertia rate. Values indicated below represent an example, not a generally valid quantitative information.

The maximum oxygen content in the reactor vessel (i.e. in particular the second limit value used according to the invention) can be specified in particular on the basis of a dimensioning of an exiting stack.

TABLE 1

| xO₂ [vol. %] | Vᵣₑₐₖ [m³/s] |
|---|---|
| 21 | 218 |
| 15 | 156 |
| 10 | 104 |
| 5 | 52 |
| 3 | 31 |
| 1 | 10 |
| 0.1 (almost | 1 |
| inert) | |

The maximum permissible pressure pₘₐₓ in the reaction vessel follows from the mechanical stability of the respective chambers or a surrounding containment. This must be at least as high as the pressure p_{box} in the event of a tube rupture or a corresponding other safety-relevant event, which in turn depends on the volume V_{Box} of the chambers involved, the exiting stack diameter D_{stack} and the oxygen mole fraction:

$${p}_{max} \geq {p}_{box} = f ( {V}_{Box} , {D}_{stack} , {x O}_{2} )$$

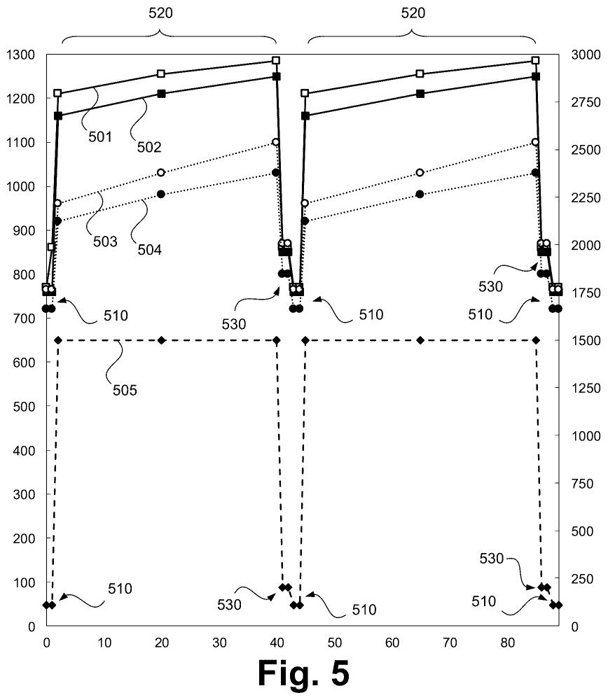

This requirement results in a design basis for the dimensioning of the exiting stack. This relationship will now be explained with reference to FIG. 5. If, for example, a maximum permissible pressure increase of 20 mbar is used as a basis, as illustrated by the dashed lines 51 and 52, a reaction-related volume increase rate of at most approx. 10 m³/s may result in order to be able to use a stack with a diameter of 500 mm (dashed line 51), which leads to a maximum oxygen content of approx. 1%. Looking at it the other way round, if one wants to use a maximum oxygen content of 1%, one must therefore use a stack diameter of at least 500 mm.

In order to be able to use a 900 mm diameter stack (dashed line 52), there must be a volume rate of no more than approx. 42 m³/s, resulting in a maximum oxygen content of approx. 4%. Conversely, and analogously to the explanations above, if a maximum oxygen content of 4% is to be used, a stack diameter of at least 900 mm must therefore be used.

The smaller the oxygen content in the reactor vessel, the smaller the increase in volume. Consequently, the diameter of the exiting stack, which has to dissipate the additional volume, can also be smaller. The decisive factor for efficient limitation of the oxygen content is always a sufficiently good seal against the environment in order to prevent or minimize the uncontrolled entry of oxygen-containing air in a sufficient manner, especially under subatmospheric pressure conditions in the interior of the reactor vessel. As explained, however, complete sealing is not required in this case.

The invention is further explained below with reference to the accompanying drawings, which illustrate embodiments of the invention with reference to and in comparison with the prior art.

In the figures, structurally or functionally corresponding elements are illustrated with identical reference signs and are not explained repeatedly for the sake of clarity. If components of devices are explained below, the corresponding explanations also refer in each case to the processes carried out with them and vice versa.

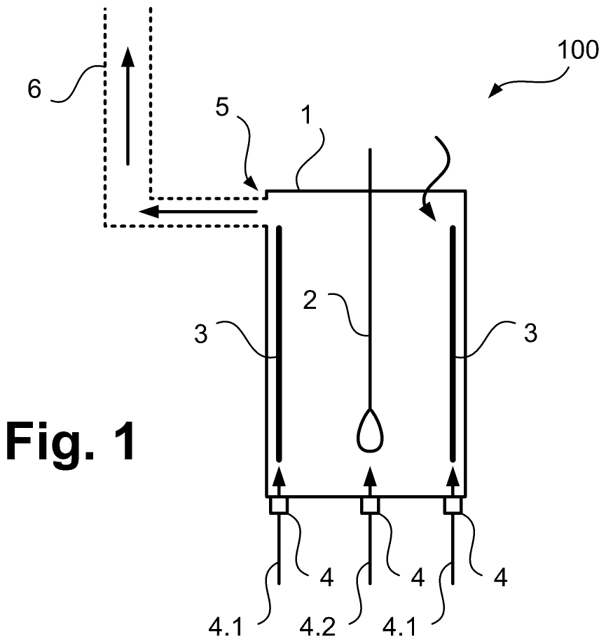

In a reactor arrangement illustrated in FIG. 1 and designated overall as 100, reaction tubes 2, illustrated in greatly simplified form and designed in the manner mentioned above, are arranged in a reactor vessel 1 also designed as explained above. Heating elements 3 of the type also explained are arranged on the wall of the reactor vessel 1, which heat the reaction tubes 2 indirectly and using radiant heat.

In the illustrated example, gas feed means 4 are arranged at the bottom of the reactor vessel 1, by means of which gases or gas mixtures with different oxygen contents can be fed in, as illustrated here with arrows 4.1 and 4.2. In the embodiment illustrated here, these gases or gas mixtures are fed in separately, whereby, in order to provide a higher oxygen content in the region of the heating elements 3, in particular a gas or gas mixture 4.1 with a higher oxygen content than that of a gas or gas mixture 4.2 can be fed in in the region of the reaction tubes 2.

By means of gas extraction means 5, here in the form of a permanently open stack opening to a stack 6, a continuous flow through the reactor vessel 1 with the previously explained advantages can be achieved with simultaneous feed via the gas feed means 4. The reactor vessel 1 can thereby be operated at a sub-atmospheric pressure level due to the lower density of the hot gas atmosphere in the stack compared to the ambient air. The inlet of air is illustrated with an unlabeled curved arrow.

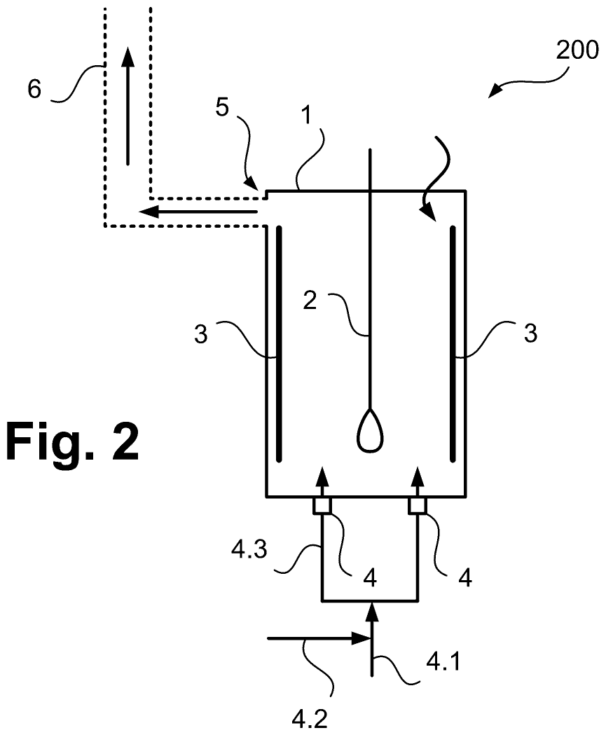

A reactor arrangement 200 illustrated in FIG. 2 differs from this essentially in that the gases or gas mixtures 4.1 and 4.2 are already mixed externally to form a gas mixture 4.3, which is fed into the reactor vessel 1 by means of the gas feed means 4.

As previously explained, all of the embodiments shown can also be operated or provided with the feed of only a single gas or gas mixture, either intermittently or permanently.

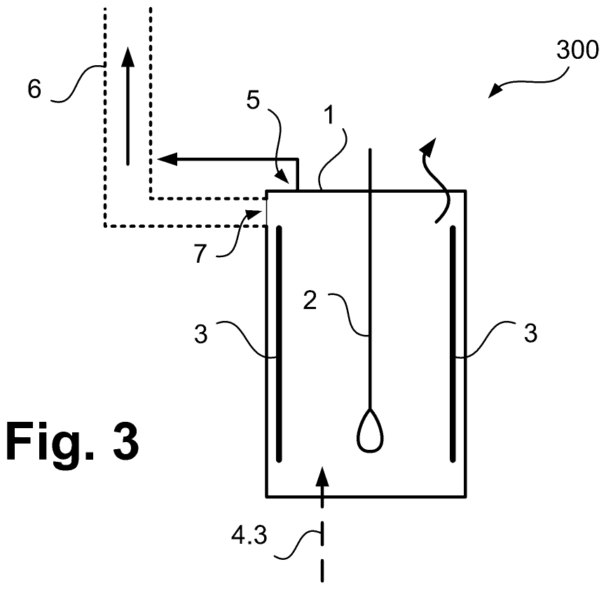

A reactor arrangement 300 illustrated in FIG. 3 differs from the previously explained designs in that a stack opening is closed by means of a bursting disc 7 or another suitable means which only opens the stack cross-section when a certain reactor vessel pressure is exceeded. Gas extraction means, also designated here as 5, establish a bypass connection to the stack 6, which in particular can be appropriately regulated and/or dimensioned. In this way, with the advantages explained, a superatmospheric pressure level can be set in the reactor vessel 1. The gas or gases used to provide the desired oxygen content in the reactor vessel 1 can be premixed or fed separately, as indicated here by a dashed arrow 4.3 for illustrative purposes. An undetermined gas loss from the reactor vessel 1 is shown with a curved arrow.

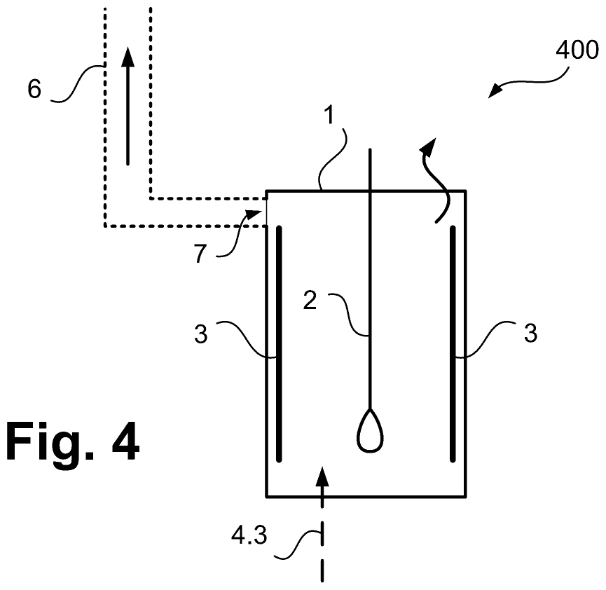

In a further embodiment of a reactor arrangement 400, which is illustrated in FIG. 4, does not comprise any permanently open gas extraction means, so that no flow-through can be set here and the reactor vessel 1 can preferably be pressurized with an appropriate gas atmosphere at the beginning or in regular time intervals. As before, the reactor vessel 1 is operated in particular at a superatmospheric pressure level.

FIG. 5 illustrates modes of operation according to one embodiment of the invention, by means of which the adjustment of certain oxygen contents in a gas atmosphere within a reactor vessel such as a reactor vessel 1 in the previously described embodiments is explained.

In the diagram of FIG. 5, a maximum temperature 501 of heating elements such as the previously explained heating elements 3, a mean temperature 502 of these heating elements, a maximum temperature 503 of reaction tubes such as the previously explained reaction tubes 2, a mean temperature 504 of these reaction tubes in ° C. (left vertical axis), and an absorbed heating power 505 of the reaction tubes 2 in kW (right vertical axis), are shown compared to an operating time of a corresponding reactor arrangement in days (horizontal axis). The absorbed heating power of the reaction tubes correlates strongly with the power input of the heating elements, since the power absorbed electrically by the heating elements is converted into heat and, merely minus the heat losses to the environment, is transferred almost completely, i.e. with a proportion of at least 85%, 90%, 95% of the power input, to the reaction tubes as absorbed heating power. The numerical values given here for the absorbed heating power refer to a group of three reaction tubes which are jointly heated by a plurality of heating elements. The invention equally relates to cracking furnaces with a modified number of reaction tubes and different amounts of absorbed heating power. In particular, the invention is also intended to be used for larger electrically operated cracking furnaces, with cumulative absorbed heat powers of more than 3, 5, 10, 20 MW.

The illustration of an exemplary sequence from standby 510 (“second” operating mode in the sense understood here) to cracking operation 520 (“first” operating mode) to decoking operation 530 (“second” operating mode) to standby operation 510 to cracking operation 520 to decoking operation 530 to standby operation 510 is simplified, in particular in the sense that only a single decoking step is shown here, corresponding to the partial step listed as an example in Table 2, and that a linearly increasing curve is shown for the maximum temperature at the reaction tube during cracking operation. In practice, the maximum temperature usually increases monotonically, but not at a constant rate over time, if the control system is designed for operation with a product gas composition that is as constant as possible, e.g. with a constant ratio of propylene to ethylene in the product gas. The plot shown of a constant absorbed heat rate of the reaction tubes during such operation is also simplified, since minor adjustments may occur here, depending on the control strategy chosen and on the growth of the coke layer on the inside of the reaction tubes. Moreover, the transition from cracking operation 520 to decoking operation 530 may also include an intermediate temporary or intermittent operation period that may be similar to a standby operation 510, although a timely decoking of the process tubes after completion of the cracking operation period is preferred to reduce the risk of coil damaging linked to the presence of a coke layer on the inside.

It is also possible to tune the control during the cracking operation to keep the product gas temperature as constant as possible, resulting in a more time-varying product gas composition and thus in larger adjustments of the absorbed heating power of the reaction tubes.

Depending on the furnace operating mode (“first” or “second” operating mode), both the upper and lower limits for the oxygen content in an atmosphere within the reactor vessel can be significantly changed when or within a short time interval to when the operating mode of the furnace changes from a flow through the reaction tubes with hydrocarbons or other reactants (reaction operation 520, “first” operating mode) to a flow without hydrocarbons (standby 510 or decoking 530 or other startup or shutdown, “second” operating mode).

In particular, it is advantageous if a lowering of the upper limit value for the oxygen content to at least the maximum permissible oxygen content for operation with hydrocarbons (i.e. the maximum value for safeguarding against a possible coil rupture scenario) is already carried out before the changeover to reaction operation mode 520. A change in the lower limit is preferably made simultaneously, e.g. to continue to maintain a sufficiently large control window for setting the gas atmosphere conditioning. Therefore, when the upper limit value is lowered before changing to reaction mode 520, the lower limit value is also preferably lowered.

In the reverse change starting from reaction operation 520, on the other hand, both limit values are preferably raised. The upper limit value can be raised to an oxygen content corresponding to the ambient air, the lower limit value is preferably raised to a value which is sufficiently far above the minimum oxygen content advantageous for the (transient) operation of the heating elements.

The increase in oxygen content in hydrocarbon-free operation can be used to advantage here, since strong changes in heating element temperatures also take place primarily during changeover operations that are carried out after shutdown or before the hydrocarbon supply is opened. In particular, this is true because significantly lower heating powers are required during hydrocarbon-free operation, which have a large effect on heater element temperatures. The heater power 505 and maximum reaction tube temperature 503 are significantly lowered when switching between reaction mode 520 to any of the other modes 510, 530, as is illustrated in FIG. 5. The heating element temperatures 501, 502 are determined by complex relationships (e.g. geometrical arrangement of reaction tubes to heating elements). Nevertheless, it can be generally stated that the temperature difference between heating elements (heat source) and reaction tubes (heat sink) strongly correlates with the heating power required in the reaction tubes. Accordingly, there are relatively high differences for the heating element temperatures between reaction mode 520 (high temperature and high heating power leads to very high heating element temperature) and the other modes 510, 530 without hydrocarbon flow (reduced coil temperature and reduced heating power lead to significantly reduced heating element temperatures). Actual heater temperatures may shift up or down depending on furnace geometry and heater design without limiting the scope of this application.

Table 2 gives an overview of representative conditions for the three main operating modes 510, 520, 530 explained for FIG. 5.

TABLE 2

| | Process gas | Heating | Heating |
|---|---|---|---|
| | temperature | power | power |
| | at the | absorbed by | relative to |
| | outlet of the | reaction | reaction |
| | reaction tubes | tubes | operation 520 |
| Operating mode | [° C.] | [kW] | [—] |
| Standby 510 | 750 | 109 | 7% |
| Example decoking | 850 | 202 | 13% |
| step 530 | | | |
| 520 reaction operation, | 850 | 1500 | 100% |
| start-of-run | | | |

In particular, targeted, even short-term changes in atmospheric conditioning, i.e. the setting of the oxygen content, as well as other process settings can be made before or after changeover processes.

Conceivable options for preparing the reactor vessel for hydrocarbon feed in reaction mode 520 include, for example, bringing the heating elements to as high a temperature as possible in a special hot steam standby in operating mode 510 (low inlet temperature into the reaction tubes with high outlet temperature) and thereby specifying a high target range for the oxygen content, and then gradually shifting the target range downwards, whereby at least the upper limit value is brought to a level below the safety-relevant limit value for enabling hydrocarbon operation or reaction operation 520.

Directly after switching from cracking operation 520 to operation without hydrocarbons, the oxygen content can be increased promptly (preferably after less than 1 h, 30 min, 10 or 1 min), in particular after closing the hydrocarbon valves, e.g. during the changeover process at the end of a cracking cycle or cracking operation 520. Preferably after completion of the subsequent decoking operation 530, a special hot steam standby with increased heating power can again be set in an operating mode 510 in order to achieve, at least intermittently, the highest possible heating element temperatures at increased oxygen concentration in the reactor vessel.

As described in detail above, in the context of the invention, adjustment of oxygen content may be made as a function of instantaneous measured values and/or target values, and additionally or alternatively as a function of temporal changes or temporal fluctuation measures of such measured values and/or target values.

In particular, non-monotonic control relationships can also be provided, e.g. hysteresis controls, i.e. different types of control during heating up or cooling down of the heating elements (since the risk of defect formation in the external oxide layer may be different during heating up and cooling down). Such hysteresis controls can be applied in particular to temperatures of heating elements or other components, process gas temperatures, as well as flow rates of partial flows and/or total flows, electrical heating powers/voltages/currents.

In particular, such an adjustment can also be performed during transient changes, e.g. load changes, within the gap, standby or decoking operation. An important example is the ramping up of the hydrocarbon flow rate after the start of the feed, during which there is a large increase in the heating power and thus also in the heating element temperatures. The invention provides that during the ramping up of the hydrocarbon load, while the oxygen range is always below the upper limit for hydrocarbon operation prescribed by safety regulations, the oxygen range is kept at a relatively high level. This transient ramp-up process can be detected by data from a temporal increase in heater temperature, heater power, hydrocarbon flow rate, or the like, and can be used accordingly as a control influence variable for altered atmospheric conditioning. Also, the instantaneous flow rate, e.g., when it reaches the normal design value, can be used to detect when a transient change of the type explained is occurring or has been completed.

Accordingly, it is practically preferred to initially set the conditioning to a tendentially higher value for the oxygen content during ramping up and then to reduce its value continuously, stepwise or at once.

This is of particular interest when ramping up the “clean” reaction tubes to the respective start of a cracking or reaction operation cycle. When ramping up non-coked tubes, the risk of coil rupture is particularly low. For this reason, a comparatively higher upper oxygen limit can be selected in this case, which can then be replaced by a lower upper oxygen limit after stable and continuous cracking operation has been reached and the build-up of a new coke layer inside the tubes has been initiated. This results in safety-optimized conditioning in continuous full-load operation.

In addition, it may also be possible to reduce the oxygen content further towards the end of the runtime, since the risk of rupture of the reaction tubes tends to increase the more the coke layer grows. At the same time, the heating element temperatures also rise, but not abruptly, so that the risk of defect formation in the protective oxide layer is lower and there are no particularly stringent requirements for the oxygen content linked to the heating element lifetime.

Preferably, it is in particular ensured at all times during the cracking operation that the conditioning gas stream added in a controlled manner has an oxygen content below the upper limit value. This is to avoid that, for example, in the course of an intermittent increase of the averaged oxygen content in the reactor vessel, the oxygen content locally rises above the currently specified upper limit value in reactor vessel areas with slow mixing.

Analogous to the described variation of the conditioning parameters in the cracking operation, similar adjustments can be carried out for the standby or decoking operations. For example, in decoking operation in particular, a variable adjustment of the conditioning can be made in parallel to the process control that changes over time (as mentioned, the decoking cycle consists of different steps that provide, among other things, different flow rates and heating capacities). The same applies, for example, to heating up the reactor vessel during commissioning. Here, time-variable atmosphere conditioning can be carried out depending e.g. on the specified temperature ramps for heating up.

1. A method of carrying out a chemical reaction using a reactor assembly in which reaction tubes arranged in a reactor vessel are provided, comprising:
during one or more first operating modes:
supplying one or more reactants to the reaction tubes in a first mass flow; and
supplying radiant heat to the reaction tubes by means of one or more electric heating elements in the reactor vessel in a first heat flow:
during one or more second operating modes:
(A):
(i) not supplying the one or more reactants to the reaction tubes; or
(ii) supplying the one or more reactants to the reaction tubes in a second mass flow, the second mass flow being lower, at least on a time-average basis, than the first mass flow; and
(B):
(i) not supplying radiant heat to the reaction tubes during the one or more second operating modes; or
(ii) supplying radiant heat to the reaction tubes in a second heat flow, the second heat flow being lower, at least on a time-average basis, than the first heat flow; and
in at least a part of the reactor vessel in which the one or more heating elements are provided, providing a gas atmosphere which is separated from the one or more reactants which are supplied to the reaction tubes by walls of the reaction tubes, and adjusting a content of oxygen is in a predetermined volume fraction, wherein,
during the one or more first modes of operation, the volume fraction of oxygen is adjusted between a first limit value of no less than 500 ppm and a second limit value of no more than 10%, and
during the one or more second operating modes, the volume fraction of oxygen is set to a value that is higher, at least on a time-average basis, than during the one or more first operating modes.

2. The method of claim 1, wherein an amount of the radiant heat supplied to the reaction tubes by means of one or more electric heating elements in the reactor vessel amounts to more than 90% of a total amount of heat supplied to the reaction tubes in the reactor vessel.

3. The method of claim 1, wherein the volume fraction of oxygen during the one or more second operating modes is adjusted between a third limit value and a fourth limit value, wherein the third limit value is above the first limit value and the fourth limit value is equal to or above the second limit value and/or wherein the third limit value is above the second limit value.

4. The method of claim 1, wherein the volume fraction of oxygen is varied over time, at least intermittently, during the one or more second modes of operation.

5. The method of claim 4, wherein the second mass flow of the one or more reactants is varied over time, at least intermittently, and/or wherein the second heat flow of the radiant heat is varied over time, at least intermittently, during the one or more second modes of operation.

6. The method of claim 5, wherein the at least intermittent variation of the volume fraction of oxygen during the one or more second modes of operation is made taking into account the at least intermittent variation of the second mass flow of the one or more reactants and/or taking into account the at least intermittent variation of the second heat flow of the radiant heat during the one or more second modes of operation.

7. The method of claim 1, wherein at least a portion of each of the reaction tubes is maintained at a reaction tube temperature in a first temperature range during the one or more first modes of operation and at a reaction tube temperature in a second temperature range below the first temperature range during the one or more second modes of operation, wherein the first temperature range is 400 to 1,500° C.

8. The method of claim 6, wherein the reaction tubes are, during the one or more second modes of operation, at least one of:
operated in a steam standby mode in which the reaction tubes are maintained at a predefined temperature or in a predefined temperature range by passing steam therethrough;
operated in a decoking mode in which the reaction tubes are decoked by passing steam and air therethrough; and
operated in a transient cracking mode in which a reaction feed load passed through the reaction tubes and/or the process gas temperature at the outlet of the reaction tubes is changed over time.

9. The method according to claim 1, further comprising:
continuously or discontinuously feeding one or more gases or gas mixtures used to provide the gas atmosphere into the reactor vessel; and
carrying out an at least partially simultaneous or at least partially time-delayed withdrawal of at least part of the gas atmosphere from the reactor vessel.

10. The method according to claim 1, wherein a subatmospheric pressure level or a superatmospheric pressure level is provided in the reactor vessel.

11. The method of claim 1, wherein one, two or more gases or gas mixtures are used to provide the gas atmosphere, wherein, when the two or more gases or gas mixtures are used, the latter comprise in particular a first gas or gas mixture having a first volume fraction of oxygen and a second gas or gas mixture having a second volume fraction of oxygen below the first volume fraction, which are fed into the reactor vessel simultaneously or not simultaneously, particularly wherein at least part of the first gas or gas mixture is fed into at least a first region of the reactor vessel, and in which at least part of the second gas or gas mixture is fed separately therefrom into at least a second region of the reactor vessel, and/or in which a gas or gas mixture is used, which is fed into a second region of the reactor vessel, while no gas or gas mixture is fed into a first region of the reactor vessel, wherein the heating elements are arranged in the at least one first region and the reaction tubes are arranged in the at least one second region of the reactor vessel.

12. The method of claim 11, wherein at least part of the first gas or gas mixture and at least part of the second gas or gas mixture are mixed outside of the reactor vessel and fed into the reactor vessel in a mixed state.

13. The method according to claim 11, wherein during and/or at the beginning and/or at the end of the reaction period and/or the heating period and/or the cooling period and/or the decoking period and/or the standby period, an actual volume fraction of oxygen is detected in at least one region of the reactor vessel and/or stack, bypass or purge lines connected thereto, and a feed of the one or more gases or gas mixtures used to provide the gas atmosphere is regulated or controlled on the basis of the detection.

14. A reactor for carrying out a chemical reaction, comprising a reactor vessel, reaction tubes arranged in the reactor vessel, and means which are arranged for:
supplying one or more reactants to the reaction tubes during one or more first operating modes in a first mass flow and not supplying the one or more reactants to the reaction tubes during one or more second operating modes or supplying the one or more reactants to the reaction tubes during the one or more second operating modes in a second mass flow, the second mass flow being lower, at least on a time-average basis, than the first mass flow,
supplying radiant heat to the reaction tubes by means of one or more electric heating elements in the reactor vessel during the one or more first operation modes in a first heat flow and not supplying the radiant heat to the reaction tubes during the one or more second operating modes or supplying the radiant heat to the reaction tubes during the one or more second operating modes in a second heat flow, the second heat flow being lower, at least on a time-average basis, than the first heat flow;
providing, in at least a part of the reactor vessel in which the one or more heating elements are provided, a gas atmosphere which is separated from the one or more reactants which are supplied to the reaction tubes by walls of the reaction tubes, and in which a content of oxygen is adjusted in a predetermined volume fraction:
adjusting, during the one or more first modes of operation, the volume fraction of oxygen between a first limit value of no less than 500 ppm and a second limit value of no more than 10%; and
setting, during the one or more second operating modes, the volume fraction of oxygen to a value that is higher, at least on a time-average basis, than during the one or more first operating modes.

15. (canceled)

16. The method of claim 1, wherein at least a portion of each of the reaction tubes is maintained at a reaction tube temperature in a first temperature range during the one or more first modes of operation and at a reaction tube temperature in a second temperature range below the first temperature range during the one or more second modes of operation, wherein the first temperature range is 500 to 1,200° C.

17. The method of claim 7, wherein the reaction tubes are, during the one or more second modes of operation, at least one of:
operated in a steam standby mode in which the reaction tubes are maintained at a predefined temperature or in a predefined temperature range by passing steam therethrough;
operated in a decoking mode in which the reaction tubes are decoked by passing steam and air therethrough; and
operated in a transient cracking mode in which a reaction feed load passed through the reaction tubes and/or the process gas temperature at the outlet of the reaction tubes is changed over time.

18. The method according to claim 12, wherein during and/or at the beginning and/or at the end of the reaction period and/or the heating period and/or the cooling period and/or the decoking period and/or the standby period, an actual volume fraction of oxygen is detected in at least one region of the reactor vessel and/or stack, bypass or purge lines connected thereto, and a feed of the one or more gases or gas mixtures used to provide the gas atmosphere is regulated or controlled on the basis of the detection.

19. The method of claim 2, wherein the volume fraction of oxygen during the one or more second operating modes is adjusted between a third limit value and a fourth limit value, wherein the third limit value is above the first limit value and the fourth limit value is equal to or above the second limit value and/or wherein the third limit value is above the second limit value.

20. The method of claim 19, wherein the volume fraction of oxygen is varied over time, at least intermittently, during the one or more second modes of operation.

21. The method of claim 3, wherein the volume fraction of oxygen is varied over time, at least intermittently, during the one or more second modes of operation.
